(19) United States
(12) Patent Application Publication
(10) Pub. No.: US 2010/0082402 A1
(43) Pub. Date: Apr. 1, 2010

(54) ESTIMATING ON-LINE ADVERTISING INVENTORY VALUE BASED ON CONTRACT DELIVERY INFORMATION

(75) Inventors: Darshan V. Kantak, Pasadena, CA (US); Jack Z. Xie, San Francisco, CA (US); Michael A. Schwarz, Berkeley, CA (US); R. Preston McAfee, San Marino, CA (US); Sai-Ming Li, Santa Clara, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/240,835

(22) Filed: Sep. 29, 2008

(51) Int. Cl. G06Q 30/00; G06Q 10/00

(52) U.S. Cl. 705/10; 705/400

(57) ABSTRACT

Disclosed are apparatus and methods for pricing on-line advertisement inventory. In one embodiment, a method for pricing on-line advertisement inventory includes (i) providing a model for determining a value of an individual impression as a function of its user target attributes based on historical bookings for a plurality of impressions, wherein each impression corresponds to a plurality of user target attributes for which an on-line advertisement can be displayed, (ii) receiving a request for a price of a new product, and (iii) determining the price of the new product based on the average of individual impression values that are determined by using the model on a plurality of user target attributes of a plurality of individual impressions that serve the new product.

### BACKGROUND OF THE INVENTION

The present invention is related to on-line advertising. It especially pertains to techniques and mechanisms for pricing on-line advertisement inventory.

For many web portals and Internet Service Providers (ISPs), advertising is a major source of revenue. One form of advertising involves showing advertisers' advertisement banners on web sites that are being visited by users. For example, a preeminent portal such as Yahoo! displays advertisers' advertisements on one or more associated web sites that are viewed by users. In return, the advertisers pay a fee for each advertisement or a predefined number of advertisements viewed by web users. Contracts to show advertisements are normally signed several weeks or months before advertisements get delivered and are often expressed in terms of page views. The duration of contracts typically ranges from one day to multiple years.

A significant portion of advertising contracts is in the form of guaranteed delivery bookings. A guaranteed booking specifies an agreement between the advertisement seller or portal and an advertiser. For example, a guaranteed booking specifies the price and the quantity of inventory, as well as the user target profile, to be delivered under the contract in advance of the advertisement being delivered or displayed.

In order to improve the efficiency of the marketplace, a pricing mechanism that reflects a true underlying value of the inventory delivered is needed. If a particular inventory is overpriced, the advertisers may become dissatisfied. Conversely, if a particular inventory is under-priced, revenue opportunities would be lost. Accordingly, it would be beneficial to provide appropriate pricing of such on-line advertising inventory.

### SUMMARY OF THE INVENTION

Accordingly, apparatus and methods for pricing on-line advertisement inventory are disclosed. In one embodiment, a method for pricing on-line advertisement inventory includes (i) providing a model for determining a value of an individual impression as a function of its user target attributes based on historical bookings for a plurality of impressions, wherein each impression corresponds to a plurality of user target attributes for which an on-line advertisement can be displayed, (ii) receiving a request for a price of a new product, and (iii) determining the price of the new product based on an average of individual impression values that are determined by using the model on a plurality of user target attributes of a plurality of individual impressions that are predicted to serve the new product.

In a specific implementation, the model is a linear model. In another implementation, the model is a nonlinear model. In certain embodiments, the user target attributes include one or more specified web properties, one or more specified position in such one or more web properties, and one or more of the following: a user's geographical location or area, a user age range, a user gender, a user income range, a user educational level, one or more user interest categories, and/or one or more user behavior characteristics.

In specific implementations, the model may be arranged such that different attributes of a particular individual impression result in different contributions to the particular individual impression's value. In a further aspect, the model may be arranged such that different individual impressions with the same type of attribute, but having different values for such same attributes, result in different values for such different individual impressions. In certain embodiments, the model is provided by iteratively adjusting a plurality of model parameters and/or attributes of the model until errors between a plurality of prices of historical bookings and a plurality of estimated values from the model are minimized.

In another embodiment, the invention pertains to an apparatus having at least a processor and a memory. The processor and/or memory are configured to perform one or more of the above described operations. In another embodiment, the invention pertains to at least one computer readable storage medium having computer program instructions stored thereon that are arranged to perform one or more of the above described operations.

These and other features of the present invention will be presented in more detail in the following specification of embodiments of the invention and the accompanying figures which illustrate by way of example the principles of the invention.

### BRIEF DESCRIPTION OF THE DRAWINGS

FIG. 1 illustrates an example network segment in which the present invention may be implemented in accordance with one embodiment of the present invention.

FIG. 2 is a flow chart illustrating a procedure for determining the price of a new product in accordance with one embodiment of the present invention.

FIG. 3 is a flow chart illustrating a process for generating a model for determining individual impression value in accordance with one embodiment of the present invention.

FIG. 4 illustrates an example computer system in which specific embodiments of the present invention may be implemented.

### DETAILED DESCRIPTION OF THE SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that they are not intended to limit the invention to these specific embodiments. On the contrary, such description is intended to cover alternatives, modifications, and equivalents as may be included within the spirit and scope of the invention as defined by the appended claims. In the following description, numerous specific details are set forth in order to provide a thorough understanding of embodiments of the present invention. Embodiments of the present invention may be practiced without some or all of these specific details. In other instances, well known process operations have not been described in detail in order not to unnecessarily obscure embodiments of the present invention.

Overview

In general, mechanisms for valuing inventory at a highly granular level are provided herein. Advertisement sellers and advertisers typically specify the product of transaction in terms of web property, position, one or more event specifications, and one or more specified user targeting parameters. The individual advertisement displays that are delivered to meet an advertiser's specified product may also be referred to as individual impressions. A web property may pertain to one or more web sites or a set of related web sites (e.g., a Finance web property). Sub-properties (e.g., a mutual fund web page from a Finance web property having multiple web pages) may also be specified. A property position may correspond to any suitable location with respect to displaying an advertisement in a particular property or sub-property. Examples of positions may correspond to particular relative positions on a web page (e.g., top, bottom, or side). An event specification may pertain to when the corresponding advertisement is displayed relative to a specified time (e.g., time of day or within a specified time-of-day window for displaying the advertisement) or one or more particular events (e.g., after occurrence of a user activity, such as performing a search in a Search property or sending an email).

A user targeting parameter may include any user characteristic that an advertisement may wish to target for advertisement purposes. User targeting parameters may include a geographical location or area, an age range, a gender, an income range, an educational level, one or more interest categories, one or more behavior characteristics, etc. Behavior characteristics may relate to tracked user activity (e.g., via user cookies), such as users that have visited specified sites, users that have visited specified sites more than a specified frequency, etc.

A good understanding of how advertisers value different aspects of online advertising inventory can be important for pricing and allocation of such inventory. A main challenge of estimating inventory value is the price paid by advertisers in each contract depends on many factors, other than the type of inventory specified in the contract. Furthermore, the inventory specification in the contract is often flexible enough to allow significant variation in the type of impressions delivered to the contract. These issues make valuation of inventory based on mere past contract prices problematic. Accordingly, certain embodiments of the present invention include mechanisms for determining inventory price by attributing the value of inventory to various factors associated with the contract. In certain embodiments, a regression model is generated that models the value of each impression that can be served to a booking based on each impression's attributes. The value of each contract can then be based on the sum of the values of all the impressions that can be served against it. One assumption of this approach that may be made is that the price paid for a contract is equal to the sum of values of individual impressions on average. This assumption allows one to use historic contract prices and the attributes of impressions served against each contract to estimate the model.

Although certain embodiments are described herein in relation to particular targeting parameters or impression attributes (such as specified web properties and user demographics), any suitable advertisement scheme may be utilized by an advertiser for displaying a particular advertisement in any suitable manner to any suitable type of person in any suitable context.

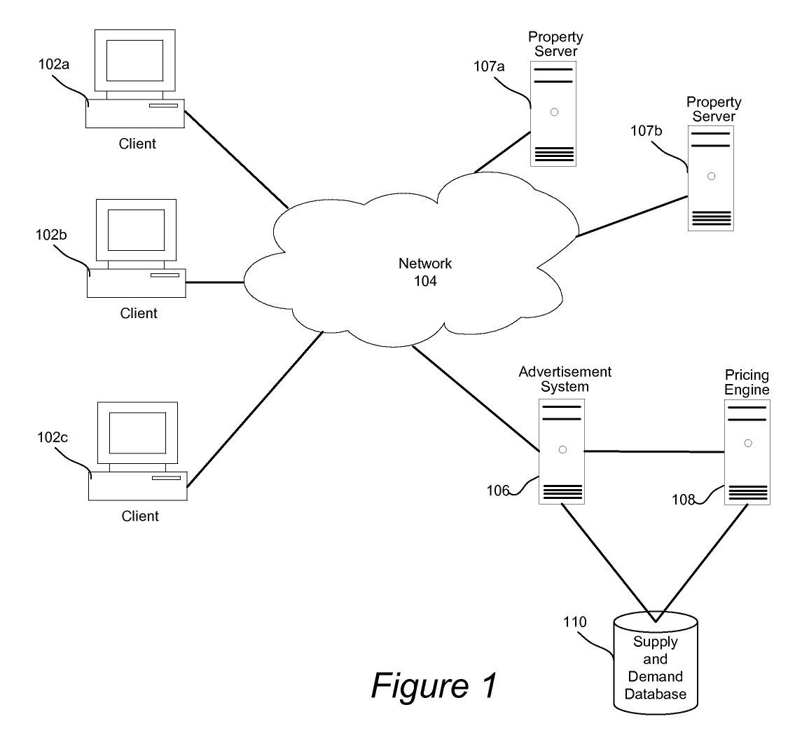

Prior to describing mechanisms for determining the price of a new product, a computer network architecture will first be briefly described to provide an example context for practicing techniques of the present invention. FIG. 1 illustrates an example network segment 100 in which the present invention may be implemented in accordance with one embodiment of the present invention. As shown, a plurality of clients 102 may access one or more web property applications, for example, on property servers 107a and 107b via network 104 and/or access an advertisement service, for example, on advertisement system server 106. The advertisement system may operate in conjunction with a pricing engine 108 that is operable to determine the price of a specified product. The advertisement system 106 and pricing engine 108 (or servers) may have access to one or more supply and demand database(s) 110 into which supply and demand information is retained.

The network may take any suitable form, such as a wide area network or Internet and/or one or more local area networks (LAN's). The network 104 may include any suitable number and type of devices, e.g., routers and switches, for forwarding web property requests from each client to each web property server and forwarding web results back to the requesting clients or for forwarding data between various servers.

The invention may also be practiced in a wide variety of network environments (represented by network 104) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

Each web property application may implement any type of web service that is provided by a particular service provider (e.g., Yahoo! Inc. of Sunnyvale, Calif.), such as Yahoo! Answers, Yahoo! Autos, Yahoo! Finance, Yahoo! Games, Yahoo! Groups, Yahoo! HotJobs, Yahoo! Maps, Yahoo! Movies/TV, Yahoo! Music, Yahoo! Personals, Yahoo! Real Estate, Yahoo Shopping, Yahoo! Sports, Yahoo! Travel, Yahoo! Yellow Pages, Yahoo! Local, Yahoo! Search, Yahoo! Email, etc. Each property application may be utilized by a user (human or automated), e.g., on clients 102a˜102c. Additionally, each web property may correspond to any suitable number and type of web pages.

Advertisement salespeople who sell guaranteed contracts to advertisers may interact with advertisement system 106 (e.g., via client 102 and through network 104). In one embodiment, a salesperson may issue a query to advertisement system 106 regarding a specified product or target. For example, the product may be specified for a particular web property, e.g., the Yahoo! email web property, a specified position for the advertisement to be displayed in such property, and particular demographics, e.g., California males who like sports and autos. The advertisement system 106 may then obtain a price for such specified product (e.g., from pricing engine 108), obtain inventory availability information (e.g., from supply and demand database 110), and return the available inventory information and price to the querying salesperson (e.g., to client 102 via network 104). The salesperson may then book a contract accordingly (e.g., with advertisement system 106 via network 104). The advertisement system 106 then operates to fill the booking by providing the number of requested impressions (e.g., via a property server) at the negotiated price during the contract period.

Embodiments of the present invention may be employed with respect to any provider of one or more web property applications and advertisement system, and example providers include Yahoo! Inc., Google Inc., Microsoft Corp., etc. A plurality of web property applications, an advertisement system, and a pricing engine may be implemented on any number of servers although only one advertisement system 106, one pricing engine 108, and two web property servers 107a and 107b are illustrated for clarity and simplification of the description.

### Product Pricing Embodiments

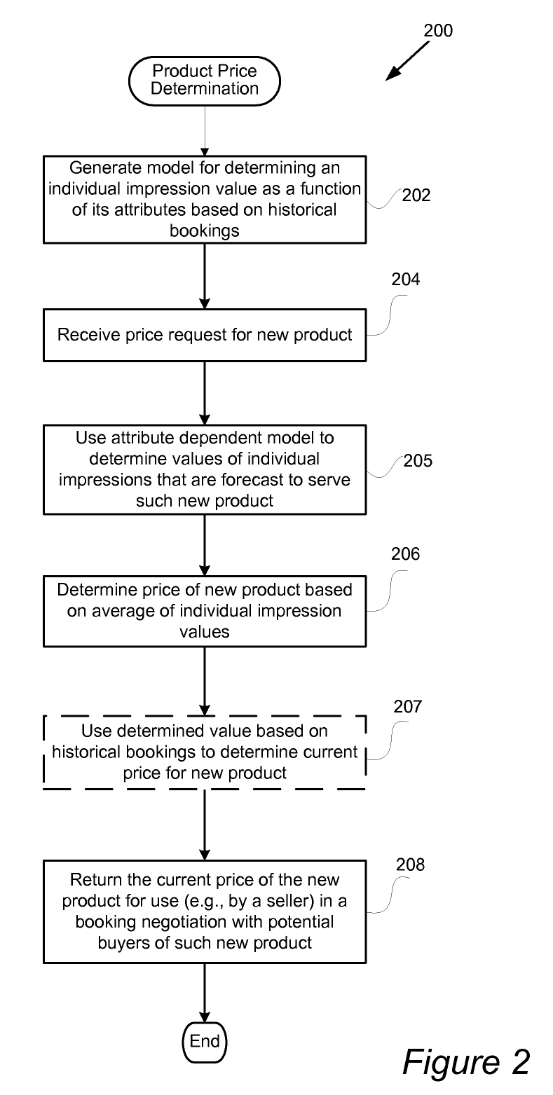

Regardless of the specific architecture, any suitable mechanism for determining the price of a specified product based on values of individual impressions and their corresponding user target attributes may be provided. FIG. 2 is a flow chart illustrating a procedure 200 for determining the price of a new product in accordance with one embodiment of the present invention. Initially, a model for determining an individual impression's value as a function of its attributes may be generated based on historical bookings in operation 202. In general, the model for determining an individual impression value depends on a set of p model parameters and a set of a impression attributes. Each individual impression value, vᵢ, may be expressed as any suitable combination of such individual impression's attributes, e.g., α₁˜αₙ, and one or more model parameters, e.g., p₁˜pₙ. The model for an individual impression value, vᵢ, may also be linear or nonlinear.

In a very simplified example, a linear model may be used for each individual impression value, vᵢ, where the model is a function of four impression attributes pertaining to property, gender, state of residence, and income level, as well as four associated model parameter values equal to $0.50, $0.25, $0.25 and $0.50, respectively:

vᵢ=$0.50×I(property=Finance)+$0.25×I(gender=male)+$0.25×I(state=CA)+$0.50×I(income>$10,000) [1]

where the function I( ) is equal to 1 if the condition in the parenthesis is true and is equal to 0 if the condition is false. For a first impression that is presented in a Finance property to a male user who has an income above $50,000 and resides in California, the value such first impression is equal to 1.5 (0.50+0.25+0.25+0.5). For a second impression that is presented in a Finance property to a female user who has an income above $50,000 and resides in the state of New York, the value is equal to 1.0 (0.5+0+0+0.5). For a third impression that is presented in a Finance property to a person with unknown gender and an income above $50,000 and has an unknown state of residence, the value is 1.0 (0.5+0+0+0.5).

Although the model illustrated by expression [1] only includes three attributes, a model would typically pertain to a higher number of different attributes. For instance, the model may include a plurality of model parameter values that each depends on one or more attribute values that include any combination of user targeting attributes as described herein. Examples of user target attributes may include property (which may specify a sub-property), one or more specified position in such one or more web properties, and one or more of the following: a user geographical location or area, a user age range, a user gender, a user income range, a user educational level, one or more user interest categories, one or more user behavior characteristics, etc.

A price request for a new product may be received in operation 204. For instance, a salesperson sends a request for a new product that is directed towards a particular type of user target or set of specified user target attributes for displaying an advertisement, such as advertising to all users of the Yahoo! Finance property who have income levels above $50,000. The request may also specify a time duration and number of impressions to be guaranteed for such time duration.

The attribute dependent model may then be used to determine values of individual impressions that are forecast to serve such new product in operation 205. The eligible impressions that can serve each booking request or new product may be determined using any suitable inventory forecasting technique for predicting inventory for a requested product. Several techniques for predicting inventory are described further below.

In a very simplified example, the above described impressions (i.e., 1. a finance property, male user who has income above $50,000 and resides in California, 2. a finance property, female user who has income above $50,000 and resides in New York, 3. a finance property user who has unknown gender and an income above $50,000 and unknown state of residence) may have been forecast to serve the new product for finance property users who have income above $50,000. If only the three impressions exemplified above were forecast to be available for the new product request, using the model of equation [1] would result in three values of $1.5 CPM, $1 CPM, and $1 CPM, respectively, as illustrated above. Of course, these numbers are merely illustrative and may each have much lower or higher values or be expressed in other units (e.g., cost per click or CPC).

The new product or new booking price may then be determined based on the average of the individual impression values in operation 206. In a simplified expression, the new product value, v, may be determined by the following expression:

$$v = \frac{1}{N} {\sum }_{i = i}^{N} {v}_{i} ( p , α ) \qquad [ 2 ]$$

where N is the number of forecast eligible impressions that have been determined to serve the new product, vᵢ is the value for each individual forecast impression as determined by the model, which was generated as a function of “p” and “α” parameters. As described above, the “p” parameters are model parameters, while the “α” parameters correspond to impression attributes and each individual impression value is determined based on a model, e.g., such as a model similar to the expression [1].

A new booking request's value will depend on the individual impression values that can serve such booking request, and these individual impression values depend on the attributes of such individual impressions. Different individual impression attributes will affect the value of such individual impression differently. That is, the model may be arranged such that different attributes of a particular individual impression result in different contributions to the particular individual impression's value. For instance, an attribute for a higher income may contribute more to the value of an impression than other attributes, such as attributes for a particular gender. The model may also be arranged such that different individual impressions with the same type of attribute, but having different values for such same attributes, result in different values for such different individual impressions. In the above example, the first impression has a gender attribute with a male value, which contributes $0.25 CMP to the impression value. In contrast, the second impression has a gender attribute with a female value, which contributes $0 CPM to the impression value. In other models, the female gender value may contribute a different nonzero CPM value to the impression value.

Additionally, since the forecast impressions will likely include other specified attribute values, in addition to the attributes specified by the new product, the new product's final value may more accurately account for values that advertisers have for certain attributes, even if such attributes are not specified by the advertisers of the new product or the advertisers of historical bookings.

The determined product price may be said to be based on historical data and may be optionally adjusted for the current day or timeframe. Referring back to FIG. 2, the value for the new product that was based on historical bookings may be used to then determine a current price for the new product in operation 207. For example, it may be determined that the current day has historically had lower or higher prices and the determined price may be adjusted accordingly to generate a current price that is more accurate for the current day. Of course, operation 207 is optional and the value that is determined for the new product may be used without being adjusted.

This current price for the new product may then be returned for use (e.g., by the requesting salesperson) in a booking negotiation with a potential buyers of such new product in operation 208. For example, the salesperson who requested the price may use such price as a minimum price that will be accepted in the contract negotiation. Alternatively, the salesperson who requested the price may offer such returned price to a user with whom she is negotiating a booking or retain such price information for later use with other potential buyers of the same new product.

Since impressions that are forecast for particular bookings may be reallocated, a new product's price may also be re-determined each time impressions are reallocated. Additionally, sales personal may be notified of new product prices so that they can negotiate bookings based on such new prices.

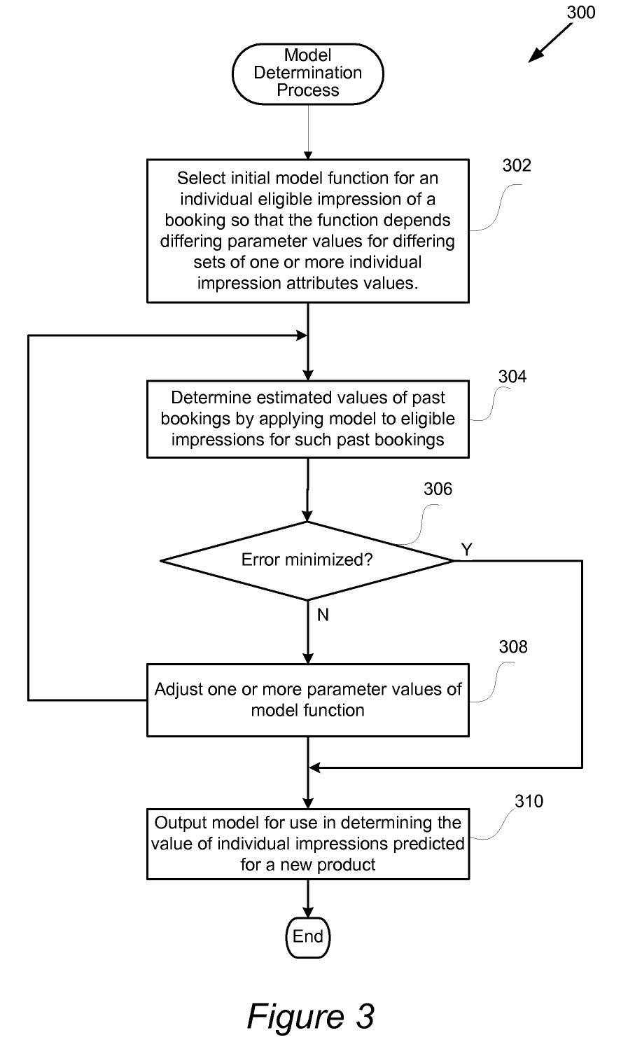

FIG. 3 is a flow chart illustrating a process 300 for generating a model for determining individual impression value in accordance with one embodiment of the present invention. In general, any suitable technique may be used to generate a model that accurately estimates the values of individual impressions so that the estimated values are within a predefined error of actual prices paid for historical bookings and their associated impressions. Example iterative processes that may be utilized include a Nelder-Mead technique, a simulated annealing method, a genetic algorithm, or any suitable combination of such techniques, etc. For example, model parameter values that are associated with each set of one or more attribute values or range of attribute values may be adjusted in a linear equation (e.g., similar to equation [1]) for determining an impression price until the errors between the actual prices of historical bookings and the estimated total values for the individual estimated impression values of such historical bookings are minimized.

Referring to the illustrated embodiment of FIG. 3, an initial model function is selected for an individual eligible impression of a booking so that the function depends on differing parameter values (e.g., p₁˜pₙ) for differing sets of one or more impression attribute values (α₁˜αₙ). In one implementation, for every possible attribute value (α₁˜αₙ), the following model may be used:

vᵢ=p₁×I(α₁)+p₂×I(α₁)+p₃×I(α3) . . . +pₙ×I(αₙ) [3]

For example, parameter values p₁˜pₙ may be set to initial values for each set of impression attribute values (α₁ through αₙ). Each of parameter p₁˜pₙ may be set to any suitable initial values and may have the same or different values. Each impression attribute value may correspond to one or more possible values of one or more attributes. For instance, an attribute value may correspond to a particular one of a predefined set of values for a particular attribute. Thus, each particular attribute value, α, in the model would have a corresponding parameter value, p, which is how much value is contributed to the individual impression value based on whether or not such individual impression has the particular attribute value.

By way of example, the attribute gender may have three predefined values: male, female, unknown. In the above expression, α₁ may correspond to a “male” value for the gender attribute; α₂ may correspond to both a “female” attribute value for the same gender attribute; and α₃ may correspond to the “unknown” value for the same gender attribute. In this example, if the impression has a gender attribute matching the α₁ male value, the parameter value p₁ contributes to impression value (and the parameters p₂ and p₃ do not contribute). Likewise, the parameter value p₂ contributes to the impression value (and the parameters p₁ and p₃ do not contribute) if the impression has a gender attribute matching the α₂ female value, and the parameter value p₃ contributes to the impression value (and the parameters p₁ and p₂ do not contribute) if the impression has a gender attribute matching the α₃ unknown value. Thus, if a particular impression is presented to a male user, the parameter value p₁ contributes to the particular impression's value, while the parameter values p₃ and p₃ do not.

The model may not include a parameter value for certain attribute values of the same type of attribute. For example, the model may include a parameter value, e.g., p₁, for a male value of a gender attribute and a parameter, e.g., p₂, for a female value of the gender attribute, while not including a parameter value for an “unknown” gender value. Additionally, each parameter, p, may be associated with more than one type of attribute. For instance, a parameter value p₄ may correspond to both a male value for a gender attribute and a California value for a residence attribute. In a more illustrative example, the parameter value p₄ contributes to such impression's value only if an impression is presented to a male user who resides in California. These simple model examples are not meant to limit the scope of the present invention. More complex conditions and nonlinear functions may be used in a model to determine the value of an individual impression.

Referring back to FIG. 3, once an initial model is selected, estimated values of past bookings may be determined by applying the initial model to the eligible impressions for such past bookings in operation 304. For instance, the particular attributes of impressions that were actually used to serve (or have been forecast to serve) a particular booking may be input into the model to determine the estimated values of such impressions, and the estimated impressions values may be summed to determine an estimated booking value. This process may be repeated for all (or a subset of) past bookings and their respective impressions.

It may then be determined whether the error is minimized between the estimated booking values and the actual booking prices in operation 306. For instance, the booking value that is estimated for a particular past booking is compared to the price actually paid for such particular booking to determine an error or difference value. An error value may be determined for all (or a subset of) past bookings. Any suitable criteria may be used to determine whether the error is minimized in operation 304. For example, it may be determined whether an average error falls below a predefined error amount or percentage difference. In another implementation, it may be determined whether each error between past booking prices and their corresponding estimated values falls below a predefined error amount or percentage difference.

If it is determined that the error is not yet minimized, one or more parameter values of the model function may be adjusted in operation 308. For example, one or more parameter values, such as p₁ through pₙ, may be adjusted so that different parameter values are used for one or more attribute values, α. Additionally, different attribute values, α, may be combined and associated with different parameter values, p, as part of the model adjustment operation 308.

When it is determined that the error has been minimized, the model may then be output for use in determining the value of individual impression predicted for a new product in operation 310, and the model determination process ends. A model may be readjusted periodically so as to tailor the model to changing advertisement conditions. Additionally, the model may be readjusted each time a new product price is needed or requested.

Certain embodiments of the present invention provide a mathematical model that models the value of individual impression as a function of impression attributes, as well as the attributes of the advertising contract that it serves (since the individual impressions that are forecast to serve the particular contract are used to determine a contract's value). Since it may be assumed that the price paid for a contract is equal to the sum of values of individual impressions on average, historic contract prices and the attributes of impressions served against each contract can be used to estimate the model.

Accordingly, certain embodiments allow a more realistic valuation of a product that is based on individual impression attributes and the contract that such individual impressions will be served against. This approach allows guaranteed contracts with new allocation to be priced appropriately. Additionally, a better understanding of how advertisers value different attributes of online advertising inventory may also be determined, even if such advertisers do not specify those attributes in their contract or contract negotiation. Advertisers who consistently obtain better value for their inventory delivery, as compared to other advertisers, can also be identified.

Inventory Forecasting

For predictions to be made in general, historical data is retained and used to extrapolate what will likely happen based on what happened in the past. According to one embodiment, historical data may be collected as users perform certain activities with respect to certain web properties. For instance, user data may be collected using cookies for a user who is logged into a service provider so that user targeting particulars can be collected along with information regarding the particular user activities. In another example, a user may download a web browser plug-in that tracks and logs web requests and responses that are sent between the user and particular web property applications. Data may also be compiled into weblogs that are records of traffic to each space compiled each day and provided by the various web servers in the network, e.g., web property servers 107a and 107b of FIG. 1. Historical data may include page view and run view (views that are made from a particular page view) histories for each major space.

An impression inventory forecaster may be provided that receives queries from an application to obtain an inventory forecast of advertisement impressions for targeting certain user profiles and returns the inventory forecast of the advertisement impressions for targeting user profiles. As used herein, a targeting user profile means one or more attributes associated with one or more users including demographics, online behavior, web page properties, and so forth. A searchable index of advertisement impressions, which are available on certain display advertising properties, may be built for a targeting profile of users from forecasted impression pools. A forecasted impression inventory indexer may generate an index of several index tables from forecasted impression pools to access trend data of forecasted impression inventory by attributes. The index may be searched to match forecasted impression pools for a targeting profile of users submitted in a query for a time period. An inventory forecast of advertisement impressions available on display advertising properties during the time period may be returned as query results for the targeting profile of attributes of users.

In one forecasting technique, historical impressions of advertisements served to online users may initially be retrieved from impression logs. In one embodiment, the impression logs may include recorded information of advertisement impressions that have been served. Impression pools with unique attributes may be created from impression logs. In one embodiment, an impression pool represents a collection of advertisement impressions that share the same attributes, such as web page attributes including properties of the web page and the web page position of an advertisement, visitor attributes such as age, gender, geographical area of residence (e.g., state or country), behavioral interests, behavior activities, time attributes such as date and hour of the day, and other attributes such as attributes of a browser. An impression pool may also include a count of the total number of impressions in the impression pool.

Samples of historical impressions may be extracted from the impression logs. To save storage and computation time, a subset of the impression logs may be processed and kept in an embodiment that may be used to generate a forecast of inventory of advertisement impressions for targeting user profiles. For example, samples representing 4% of historical impressions may be used. The extracted samples of historical impressions may be assigned to impression pools. An impression pool may be defined by attributes such as time attributes, user demographics attributes, behavior attributes, web page attributes and so forth. A sample advertisement impression may be assigned to one or more impression pools that share the unique attributes of the sample impression. For example, a web page may belong to multiple properties or sub-properties and each of the properties or sub-properties may be listed as its web page attribute.

Trend forecast data may be retrieved for untargeted inventory forecasting of advertisement impressions. Impression pools of sample impressions may be matched to trend forecast for display advertising properties to generate forecasted impression pools. In one embodiment, the attributes from an impression pool may be used to match a web page property or collection of related web pages in an inventory trend forecast table with columns including a web page property or collection of related web pages, web page position of an advertisement, and the ratio of the number of forecasted impressions on a given date to the number of actual impressions on a reference date in the past. Each forecasted impression pool may include the information from an impression pool and a pointer to a row in the inventory trend table for a matching display advertising property.

An index of index tables may be built for the forecasted impression pools. In a specific application, there may be millions of forecasted impression pools, each of which may contain dozens or even hundreds of attributes. An efficient indexing technology known in the art, such as FastBit, may be used in one implementation to scan the forecasted impression pools and build an index table for each attribute value. The index of index tables may then be stored for the forecasted impression pools.

Once the index tables are built, the data can be queried very efficiently. A query specifying a targeting profile of attributes of users and a time period may be received. For instance, a query may specify the following attributes of a targeting profile: “property=Finance”, “age>30”, and “country=US”. The time period may be specified as a data range such as “7/1/2009 to 12/31/2009”. The index may be searched to find forecasted impression pools that match the targeting profile of attributes of users.

An inventory forecast may be determined by summing trend forecast data during the time period specified in the query for each matching forecasted impression pool. In one embodiment, for each date in the time period specified in the query, the trend forecast data may be computed for each matching impression pool and then it may be added to the total inventory forecast. The inventory forecast of advertisement impressions available on display advertisement properties available during the time period may be output for targeting the profile of attributes of users.

The forecast of an inventory of online advertisement impressions may be generated to target many different user profiles. For instance, web page attributes such as properties of the page and the web page position of an advertisement may be used. User attributes for online behavior and/or demographics including age, gender, and country, may be used for targeting user profiles. Or user profiles may be targeted by time, browser attribute or type, and so forth. Certain embodiments may provide accurate forecasting for any combination of thousands of targeting attributes. Thus, certain embodiments may provide a publisher with the capability to forecast available inventories of advertisement impressions for targeting different combinations of attributes before selling them to online advertisers who would like to target users visiting certain web pages with certain demographics, geographies, behavioral interests, as well as many other attributes.

Other forecasting techniques may be used herein and modified to forecast individual impressions for a particular impression request, such as the forecasting techniques that are further described in U.S. application, having Publication No. 2005/0050215 A1, published 3 Mar. 2005, by Long-Ji Lin et al., entitled “Systems and Methods for Predicting Traffic on Internet Sites”, which patent application is incorporated herein by reference in its entirety for all purposes.

Computer System

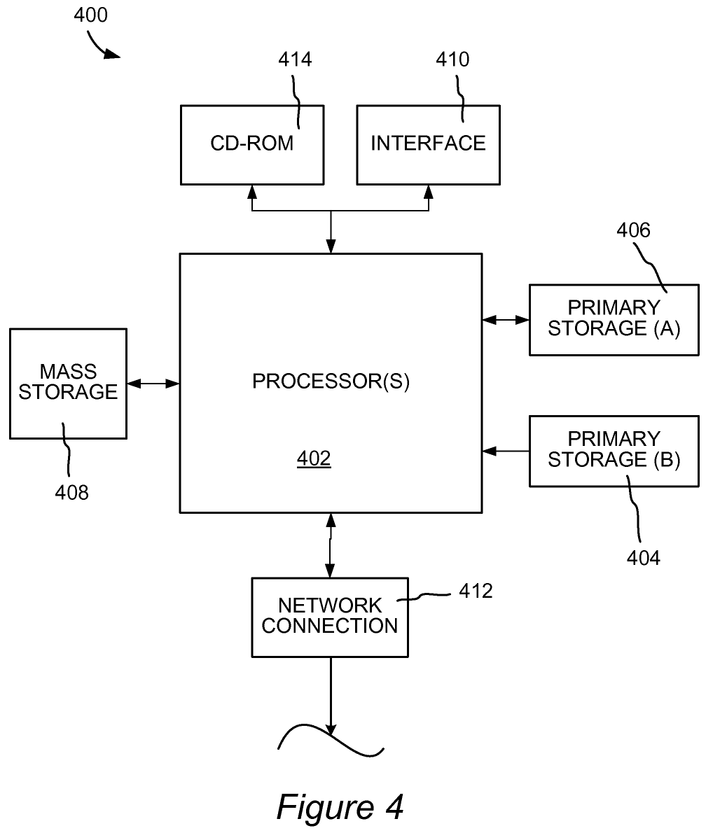

FIG. 4 illustrates a typical computer system that, when appropriately configured or designed, can serve as an advertisement pricing system. The computer system 400 includes any number of processors 402 (also referred to as central processing units, or CPUs) that are coupled to storage devices including primary storage 406 (typically a random access memory, or RAM), primary storage 404 (typically a read only memory, or ROM). CPU 402 may be of various types including microcontrollers and microprocessors such as programmable devices (e.g., CPLDs and FPGAs) and unprogrammable devices such as gate array ASICs or general-purpose microprocessors. As is well known in the art, primary storage 404 acts to transfer data and instructions uni-directionally to the CPU and primary storage 406 is used typically to transfer data and instructions in a bi-directional manner. Both of these primary storage devices may include any suitable computer-readable media such as those described herein. A mass storage device 408 is also coupled bi-directionally to CPU 402 and provides additional data storage capacity and may include any of the computer-readable media described herein. Mass storage device 408 may be used to store programs, data and the like and is typically a secondary storage medium such as a hard disk. It will be appreciated that the information retained within the mass storage device 408, may, in appropriate cases, be incorporated in standard fashion as part of primary storage 406 as virtual memory. A specific mass storage device such as a CD-ROM 414 may also pass data uni-directionally to the CPU.

CPU 402 is also coupled to an interface 410 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 402 optionally may be coupled to an external device such as a database or a computer or telecommunications network using an external connection as shown generally at 412. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store new impression attributes, booking prices, booking durations, number of impressions for each booking, forecast impressions that cover each booking, supply and demand information, models and model parameters, estimated booking values, error values between estimated and actual booking prices, new product prices, average prices of impressions on the non-guaranteed market, etc.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method for pricing on-line advertisement inventory, comprising:
providing a model for determining a value of an individual impression as a function of its user target attributes based on historical bookings for a plurality of impressions, wherein each impression corresponds to a plurality of user target attributes for which an on-line advertisement can be displayed;
receiving a request for a price of a new product; and
determining the price of the new product based on an average of individual impression values that are determined by using the model on a plurality of user target attributes of a plurality of individual impressions that are predicted to serve the new product.

2. The method as recited in claim 1, further comprising:
using the determined value, which was based on historical bookings, to determine a current price of the new product; and
returning the price of the new product for use in a booking negotiation with a potential buyer of such new product.

3. The method as recited in claim 1, wherein the model is a linear model.

4. The method as recited in claim 1, wherein the model is a nonlinear model.

5. The method as recited in claim 1, wherein the user target attributes include one or more specified web properties, one or more specified position in such one or more web properties, and one or more of the following: a user's geographical location or area, a user age range, a user gender, a user income range, a user educational level, one or more user interest categories, and/or one or more user behavior characteristics

6. The method as recited in claim 1, wherein the value of the new product is determined by averaging all of the individual impression values.

7. The method as recited in claim 1, wherein the model is arranged such that different attributes of a particular individual impression result in different contributions to the particular individual impression's value.

8. The method as recited in claim 1, wherein the model is arranged such that different individual impressions with a same type of attribute, but having different values for such same attributes, result in different values for such different individual impressions.

9. The method as recited in claim 1, wherein the model is provided by iteratively adjusting a plurality of model parameters and/or attributes of the model until errors between a plurality of prices of historical bookings and a plurality of estimated values from the model are minimized.

10. An apparatus comprising at least a processor and a memory, wherein the processor and/or memory are configured to perform the following operations:
providing a model for determining a value of an individual impression as a function of its user target attributes based on historical bookings for a plurality of impressions, wherein each impression corresponds to a plurality of user target attributes for which an on-line advertisement can be displayed;
receiving a request for a price of a new product; and
determining the price of the new product based on an average individual impression values that are determined by using the model on a plurality of user target attributes of a plurality of individual impressions that are predicted to serve the new product.

11. The apparatus as recited in claim 10, wherein the processor and/or memory are further configured to perform the following operations:
using the determined value, which was based on historical bookings, to determine a current price of the new product; and
returning the price of the new product for use in a booking negotiation with a potential buyer of such new product.

12. The apparatus as recited in claim 10, wherein the model is a linear model.

13. The apparatus as recited in claim 10, wherein the model is a nonlinear model.

14. The apparatus as recited in claim 10, wherein the user target attributes include one or more specified web properties, one or more specified position in such one or more web properties, and one or more of the following: a user's geographical location or area, a user age range, a user gender, a user income range, a user educational level, one or more user interest categories, and/or one or more user behavior characteristic.

15. The apparatus as recited in claim 10, wherein the value of the new product is determined by averaging all of the individual impression values.

16. The apparatus as recited in claim 10, wherein the model is arranged such that different attributes of a particular individual impression result in different contributions to the particular individual impression's value.

17. The apparatus as recited in claim 10, wherein the model is arranged such that different individual impressions with a same type of attribute, but having different values for such same attributes, result in different values for such different individual impressions.

18. The apparatus as recited in claim 10, wherein the model is provided by iteratively adjusting a plurality of model parameters and/or attributes of the model until errors between a plurality of prices of historical bookings and a plurality of estimated values from the model are minimized.

19. At least one computer readable storage medium having computer program instructions stored thereon that are arranged to perform the following operations:
providing a model for determining a value of an individual impression as a function of its user target attributes based on historical bookings for a plurality of impressions, wherein each impression corresponds to a plurality of user target attributes for which an on-line advertisement can be displayed;
receiving a request for a price of a new product; and
determining the price of the new product based on an average of individual impression values that are determined by using the model on a plurality of user target attributes of a plurality of individual impressions that are predicted to serve the new product.

20. The least one computer readable storage medium as recited in claim 19, wherein the computer program instructions are further arranged to perform the following operations:
using the determined value, which was based on historical bookings, to determine a current price of the new product; and
returning the price of the new product for use in a booking negotiation with a potential buyer of such new product.

21. The least one computer readable storage medium as recited in claim 19, wherein the model is a linear model.

22. The least one computer readable storage medium as recited in claim 19, wherein the model is a nonlinear model.

23. The least one computer readable storage medium as recited in claim 19, wherein the user target attributes include one or more specified web properties, one or more specified position in such one or more web properties, and one or more of the following: a user's geographical location or area, a user age range, a user gender, a user income range, a user educational level, one or more user interest categories, and/or one or more user behavior characteristics.

24. The least one computer readable storage medium as recited in claim 19, wherein the value of the new product is determined by averaging all of the individual impression values.

25. The least one computer readable storage medium as recited in claim 19, wherein the model is arranged such that different attributes of a particular individual impression result in different contributions to the particular individual impression's value.

26. The least one computer readable storage medium as recited in claim 19, wherein the model is arranged such that different individual impressions with a same type of attribute, but having different values for such same attributes, result in different values for such different individual impressions.

27. The least one computer readable storage medium as recited in claim 19, wherein the model is provided by iteratively adjusting a plurality of model parameters and/or attributes of the model until errors between a plurality of prices of historical bookings and a plurality of estimated values from the model are minimized.
